(19) United States
(12) Patent Application Publication
(10) Pub. No.: US 2012/0068886 A1
(43) Pub. Date: Mar. 22, 2012

(54) GLOBAL POSITIONING SYSTEM TRACKING DEVICE

(75) Inventor: Freddy Torres, St. Albans, NY (US)

(73) Assignee: CONSOLIDATED EDISON COMPANY OF NEW YORK, INC., New York, NY (US)

(21) Appl. No.: 12/884,945

(22) Filed: Sep. 17, 2010

(51) Int. Cl. G01S 19/34

(52) U.S. Cl. 342/357.74

(57) ABSTRACT

A global positioning system (GPS) tracking device that includes a casing including a GPS transmitting and receiving unit configured to transmit and receive GPS signals including GPS routing information; a signal amplifying unit coupled with the GPS transmitting and receiving unit and configured to amplify cell signals; and a timing unit configured to receive power from an external power supply unit and to control power supply to the GPS transmitting and receiving unit and the signal amplifying unit for a predetermined time period

### BACKGROUND OF THE INVENTION

The present invention relates generally to a global positioning system (GPS) and in particular to a GPS tracking device for use in service vehicles.

GPS is a space-based global navigation satellite system that provides location and time information. Today, GPS tracking systems are being installed in service vehicles to be used by field technicians. These systems are being installed in the service vehicles by mounting and connecting a plurality of separate components within the vehicle, for example, under the vehicle hood or in other unexposed space within the vehicle. The current installation methods may cause several problems, for example, incorrect installation of any of the components may prevent proper operation of the system, and exposed connections and wires risk unauthorized tampering and possible damage.

Accordingly, while existing systems and methods for performing GPS tracking and the installation of these systems may be suitable for their intended purposes, there still remains a need for improvements particularly regarding the manufacturing of and the assembly of GPS equipment in service vehicles to prevent any of the above-mentioned drawbacks.

### SUMMARY OF THE INVENTION

According to an embodiment of the present invention, a global positioning system (GPS) tracking device is provided. The GPS tracking device includes a casing including a GPS transmitting and receiving unit configured to transmit and receive GPS signals including GPS routing information; a signal amplifying unit coupled with the GPS transmitting and receiving unit and configured to amplify cell signals; a timing unit configured to receive power from an external power supply unit and to control power supply to the GPS transmitting and receiving unit and the signal amplifying unit for a predetermined time period;

According to another embodiment of the present invention, a method of operating a global positioning system (GPS) tracking device is provided. The GPS tracking system is mounted to a vehicle and includes a casing including a GPS transmitting and receiving unit, a signal amplifying unit, and a timing unit. The method includes supplying power from an external power supply unit to the timing unit; supplying power to the GPS transmitting and receiving unit and the signal amplifying unit via the timing unit for a predetermined period of time; and transmitting and receiving GPS signals including GPS routing information via a GPS antenna that is coupled to the GPS transmitting and receiving unit.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram illustration of a vehicle including GPS tracking device mounted thereto that can be implemented within embodiments of the present invention.

FIG. 2 is a block diagram illustration a GPS tracking device that can be implemented within embodiments of the present invention.

FIG. 3 is a drawing illustration of the casing of the GPS tracking device that can be implemented within embodiments of the present invention.

FIG. 4 is a flow diagram illustration of a method of performing GPS tracking utilizing the GPS tracking device of FIG. 1 that can be implemented within embodiments of the present invention.

The detailed description explains embodiments of the invention, together with advantages and features, by way of example with reference to the drawings.

### DETAILED DESCRIPTION

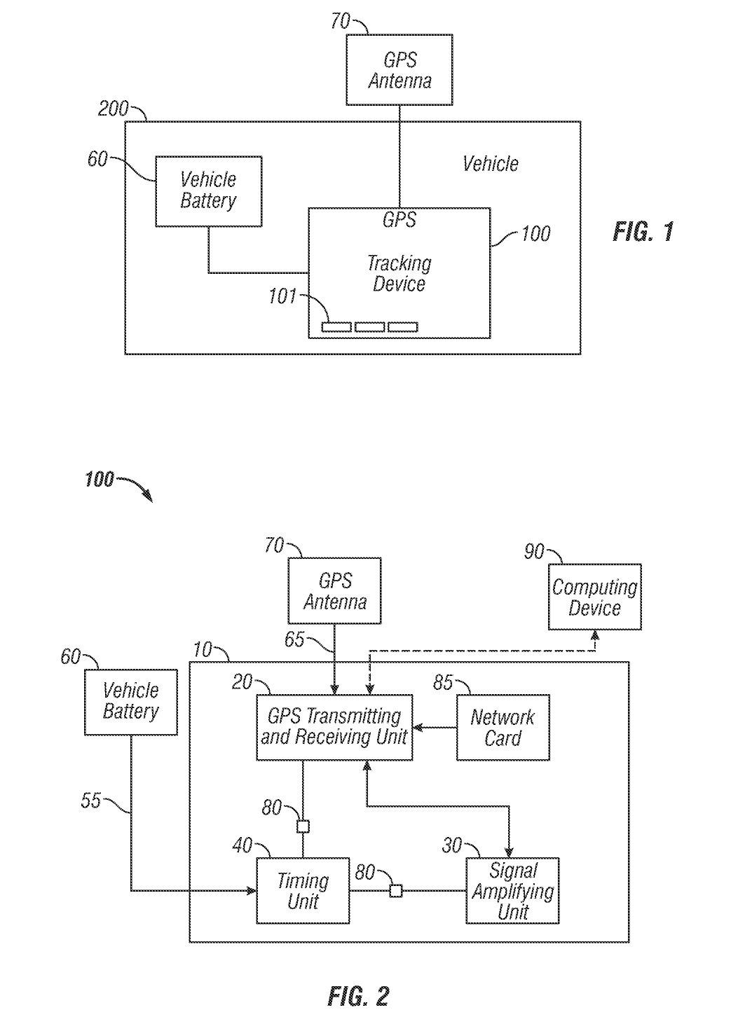

The present invention discloses a GPS tracking device that may be utilized in service vehicles, for example, by field technicians in a utility service environment. According to an embodiment of the present invention, a GPS tracking device 100 is provided as shown in FIG. 1 that may be connected to a vehicle battery 60 of a vehicle 200. A GPS antenna 70 may also be attached to the vehicle (e.g. roof) for receiving and transmitting GPS data. Details regarding the GPS tracking device 100 will now be described below and referencing FIG. 2.

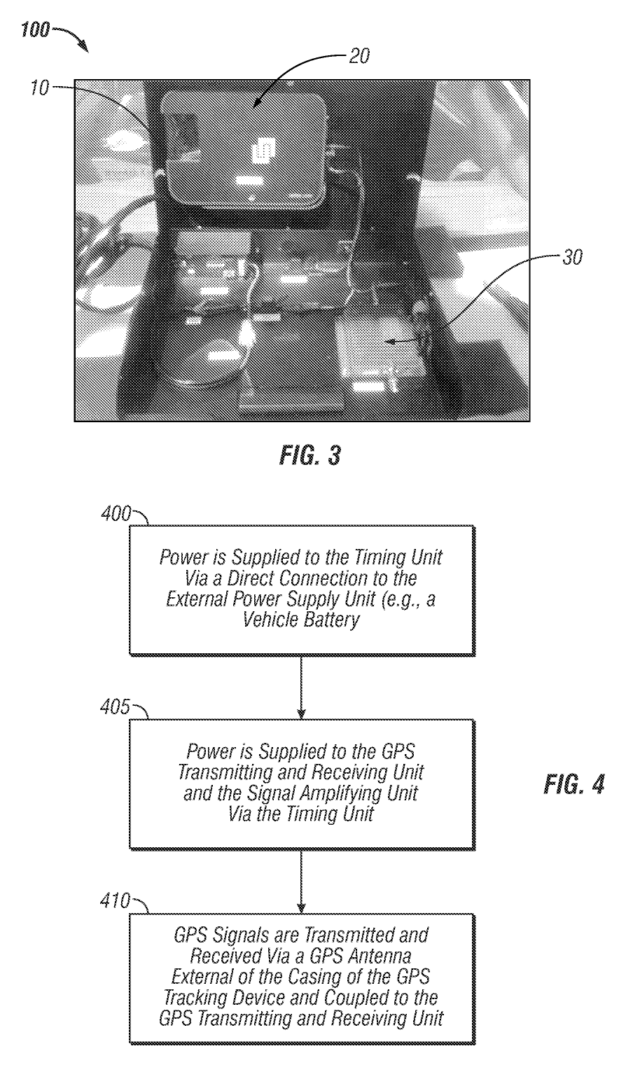

As shown in FIG. 2, the GPS tracking device 100 includes a casing 10. According to an embodiment of the present invention, the casing 10 is formed of a tempered resistant material to prevent damage to the components of the GPS tracking device 100. Further, the casing 10 is formed of a material that will not interfere with wireless networking and GPS signals, and is durable to protect the hardware components of the GPS tracking device 100. Some examples of the material of the casing 10 include, steel box, as pictured in FIG. 3, or a plastic casing would be preferred to reduce interference. The casing 10 includes a GPS transmitting and receiving unit 20 configured to transmit and receive GPS signals including GPS routing information via the GPS antenna 70 extending from the vehicle 200 and coupled to the GPS transmitting and receiving unit 20 via an electrical cable 65. According to an embodiment of the present invention, the GPS transmitting and receiving unit 20 may be a GPS Rocket manufactured by Utility Associates, for example, or any transmitter and receiver that is suitable for the purpose set forth herein. The casing 10 further includes a signal amplifying unit 30 (e.g., a signal booster) coupled with the GPS transmitting and receiving unit 20 and configured to amplify the cell signals. According to an embodiment of the present invention, the GPS transmitting and receiving unit 20 may be mounted within an interior surface of the casing 10 as shown in FIG. 3 and the signal amplifying unit 30 may be mounted in a separate location from the GPS transmitting and receiving unit 20 as shown in FIG. 3 or it may be mounted to a surface of the GPS transmitting and receiving unit 20.

Referring back to FIG. 2, according to an embodiment of the present invention, the GPS transmitting and receiving unit 20 and the signal amplifying unit 30 are coupled with a timing unit 40 also disposed within the casing 10. The timing unit 40 is configured to control power supply to the GPS transmitting and receiving unit 20 and the signal amplifying unit 30 for a predetermined time period. According to an embodiment of the present invention, An input side of the timing unit 40 is directly connected to the vehicle battery 60 via electrical cable 55 and an output side of the timing unit 40 supplies power to the signal amplifying unit 30 and the GPS transmitting and receiving unit 20. According to an embodiment of the present invention, the timing unit 40 is directly connected between the external power supply unit 60 the GPS transmitting and receiving unit 20 and the signal amplifying unit 30 and is configured to automatically disconnect power supply to at least one of the GPS transmitting and receiving unit 20 and the signal amplifying unit 30 a predetermined time period after shut-off of the vehicle 200 (as depicted in FIG. 1). For example, the timing unit 40 may be preset to disconnect the power supply 15 minutes, or 1 hour after shut-off of the vehicle 200 to preserve the life of the battery.

According to an embodiment of the present invention, the GPS tracking device 100 is also capable of accessing a wireless network (e.g., the Internet) via a network card 85 disposed within the casing. According to an embodiment of the present invention, the network card 85 may be an air card, a connect card or a mobile broadband card, for example which plugs into the GPS transmitting and receiving unit 20. The GPS transmitting and receiving unit 20 transmit the GPS signals to an external server (e.g. the manufacturer's server and/or a client server) wirelessly via the GPS antenna 70. The GPS data may be retrieved via a computing device 90 (e.g. a laptop) configured with software instructions for viewing the GPS data. The computing device 90 is able to obtain a wireless signal transmitting by the GPS transmitting and receiving unit 20.

According to another embodiment of the present invention, status indicators 101 (as depicted in FIG. 1) may be disposed on an external surface of the casing 10 and configured to indicate status information of at least one of the timing unit 40, the GPS transmitting and receiving unit 20, and the signal amplifying unit 30. The status information may include operating information e.g., an on-state, an off-state, an idle state, or a warning state of the components.

According to an embodiment of the present invention, the GPS tracking device 100 may be pre-assembled during a manufacturing process as a single integrated unit as shown in FIGS. 1 through 3. Therefore, the device 100 may be installed in the vehicle 200 as a single unit. Therefore, reducing installation complexity and preventing tampering of the individual components and damage thereto and enabling more simplistic maintenance of the GPS tracking device 100. According to one embodiment of the present invention, the GPS tracking device 100 is a plug-and-play type box. The only components extending from the casing 10 are the electrical cables 55 and 65 as shown in FIG. 2.

According to an embodiment of the present invention, the GPS tracking device 100 further includes a plurality of overcurrent protection devices (e.g., fuses) 80 disposed between the timing unit 40 and the GPS transmitting and receiving unit 20 and the signal amplifying unit 30. These overcurrent protection devices 80 are configured to disconnect power supply to at least one of the GPS transmitting and receiving unit 20 and the signal amplifying unit 30 in the event of excessive current flow through the GPS tracking device 100.

A method for operating the GPS tracking device 100 will now be described below and referencing FIG. 4. As shown in FIG. 4, at operation 400, when desired, power is supplied to the timing unit 40 via an external power supply unit 60 of the vehicle 200 (e.g. a vehicle battery). From operation 400, the process continues to operation 405, where the power is supplied to the GPS transmitting and receiving unit 20 and the signal amplifying unit 30 via the timing unit 40 for a predetermined period of time. From operation 405, the process continues to operation 410 where GPS signals including GPS routing information are transmitted and received via the GPS antenna 70 external of the casing 10 of the GPS tracking device 100 and coupled to the GPS transmitting and receiving unit 20. The cell signals are amplified via the signal amplifying unit 30.

According to an embodiment of the present invention, a predetermined period of time after vehicle shut-off, the power supply is automatically disconnected, via the timing unit, to at least one of the GPS transmitting and receiving unit and the signal amplifying unit. Further, status indicators disposed at an external surface of the casing 10, indicate the status information of at least one of the timing unit 40, the GPS transmitting and receiving unit 20, and the signal amplifying unit 30.

The GPS tracking device according to the present invention is a self-contained system (i.e., a one source box) that provides the advantages of conveniently disposing all components of the device in a single integrated unit that can be pre-assembled during a manufacturing process, and mounting the GPS tracking device in one location within a vehicle for example, to prevent tampering of the individual components of the device. Further, the casing of the device is made of a tempered resistant material that protects the components of the device from damage and reduces the number of connections required during installation thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A global positioning system (GPS) tracking device comprising:
a casing comprising:
a GPS transmitting and receiving unit configured to transmit and receive GPS signals including GPS routing information;
a signal amplifying unit coupled with the GPS transmitting and receiving unit and configured to amplify cell signals; and
a timing unit configured to receive power from an external power supply unit and to control power supply to the GPS transmitting and receiving unit and the signal amplifying unit for a predetermined time period.

2. The GPS tracking device of claim 1, further comprising:
a network card coupled to the GPS transmitting and receiving device and configured to access a wireless network.

3. The GPS tracking device of claim 1, wherein the external power supply unit comprises a battery of a vehicle.

4. The GPS tracking device of claim 3, wherein the timing unit is configured to automatically disconnect power supply to at least one of the GPS transmitting and receiving unit and the signal amplifying unit a predetermined time period after shut-off of the vehicle.

5. The GPS tracking device of claim 1, further comprising:
status indicators disposed on an external surface of the casing and configured to indicate status information of at least one of the timing unit, the GPS transmitting and receiving unit; and the signal amplifying unit.

6. The GPS tracking device of claim 1, wherein the casing is formed of a tempered resistant material.

7. The GPS tracking device of claim 1, wherein the GPS transmitting and receiving unit is coupled to a GPS antenna for receiving and transmitting GPS signals, wherein the GPS antenna is external of the casing of the GPS tracking device.

8. The GPS tracking device of claim 1, wherein the GPS tracking device is preassembled during a manufacturing process as a single integrated unit.

9. The GPS tracking device of claim 1, further comprising:
a plurality of overcurrent protection devices disposed between the timing unit and the GPS transmitting and receiving unit and the signal amplifying unit, and configured to disconnect power supply to at least one of the GPS transmitting and receiving unit and the signal amplifying unit during excessive current flow.

10. The GPS tracking device of claim 1, wherein the casing is a plug-and-play type box.

11. The GPS tracking device of claim 2, wherein the network card is a mobile broadband or air card plugged into the GPS transmitting and receiving unit to allow wireless network access via a computing device.

12. A method of operating a global positioning system (GPS) tracking device mounted to a vehicle and including a casing comprising a GPS transmitting and receiving unit, a signal amplifying unit, and a timing unit, the method comprising:
supplying power to the timing unit via a direct connected with an external power supply unit of the vehicle;
supplying power to the GPS transmitting and receiving unit and the signal amplifying unit via the timing unit for a predetermined period of time; and
transmitting and receiving GPS signals including GPS routing information via a GPS antenna coupled to the GPS transmitting and receiving unit.

13. The method of claim 12, further comprises:
amplifying cell signals via the signal amplifying unit.

14. The method of claim 12, further comprising:
accessing a wireless network via a network card plugged into the GPS transmitting and receiving unit and disposed within the casing.

15. The method of claim 12, wherein the external power supply unit comprises a battery of the vehicle.

16. The method of claim 12, further comprising:
automatically disconnecting power supply, via the timing unit, the GPS transmitting and receiving unit and the signal amplifying unit at a predetermined time period after shut-off of the vehicle.

17. The method of claim 12, further comprising:
indicating status information, via status indicators disposed at an external surface of the casing, of at least one of the timing unit, the GPS transmitting and receiving unit, and the signal amplifying unit.

18. The method of claim 12, wherein the casing is formed of a tempered resistant material.
